(19) United States
(12) Patent Application Publication
(10) Pub. No.: US 2022/0083976 A1
(43) Pub. Date: Mar. 17, 2022

(54) DIGITAL TWIN BASED SUPPLY CHAIN ROUTING

(71) Applicant: International Business Machines Corporation, Armonk, NY (US)

(72) Inventors: Sarbajit K. Rakshit, Kolkata (IN); Mukundan Sundararajan, Bangalore (IN)

(21) Appl. No.: 17/023,462

(22) Filed: Sep. 17, 2020

(51) Int. Cl. G06Q 10/08; G06Q 10/06

(52) U.S. Cl. CPC G06Q 10/08355; G06Q 10/06315; G06Q 10/067

(57) ABSTRACT

Methods, computer program products and/or systems are provided that perform the following operations: obtaining a digital replica model for each of a plurality of supplier systems; receiving data feeds from each of the plurality of supplier systems; simulating real-time operation of each of the plurality of supplier systems based on the digital replica models and the data feeds; identifying a predicted change in capacity for a supplier system based, at least in part, on the operation simulations of each of the plurality of supplier systems; and determining a supply chain routing for a component order based, at least in part, on the identification of the predicted change in capacity for the supplier system.

### BACKGROUND

The present invention relates generally to the field of digital modeling, and more particularly to providing for the utilization of digital replica (e.g., “digital twin”) modeling in determinations of supply chain order routing.

A digital twin provides an exact virtual/digital replica of a physical entity (e.g., machine, product, system, process, service, and/or the like) creating a link between the physical and digital worlds. A digital twin can enable simulation, testing, modeling, analysis, and/or monitoring based on data generated by and/or collected from the digital twin.

### SUMMARY

According to an aspect of the present invention, there is a method, computer program product and/or system that performs the following operations (not necessarily in the following order): obtaining a digital replica model for each of a plurality of supplier systems; receiving data feeds from each supplier system; simulating real-time operation of each of the plurality of supplier systems based on the digital replica models and the data feeds; identifying a predicted change in capacity for a supplier system based, at least in part, on the operation simulations of each of the plurality of supplier systems; and determining a supply chain routing for a component order based, at least in part, on the identification of the predicted change in capacity for the supplier system.

### BRIEF DESCRIPTION OF THE DRAWINGS

FIG. 1 is a block diagram view of a first embodiment of a system, according to the present invention;

FIG. 2 is a flowchart showing a first embodiment method performed, at least in part, by the first embodiment system;

FIG. 3 is a block diagram showing an example machine logic (for example, software) portion of the first embodiment system;

FIG. 4 is a block diagram showing an example of a supply chain, according to the present invention; and

FIG. 5 is a block diagram showing an embodiment for providing supply chain order routing determinations, according to the present invention.

### DETAILED DESCRIPTION

According to aspects of the present disclosure, systems and methods can be provided to generate predictions and/or determinations regarding supply chain order routing through utilization of digital replica (e.g., digital twin) modeling of a supply chain. A digital twin model provides a virtual/digital replica or representation of a physical entity (e.g., machine, product, system, process, service, and/or the like) creating a link between the physical and digital worlds. In particular, systems and methods of the present disclosure can provide for simulation of machines, systems, and/or the like associated with suppliers in a supply chain. The systems and methods of the present disclosure can generate predictions with regard to the supplier machines/systems, for example, regarding quality deterioration, reduction in throughput, available capacity, increased capacity, and/or the like, for use in determining supply chain order routing (e.g., determining a supplier for a new order, determining if an order should be routed to an alternate supplier, etc.) to minimize delays and satisfy delivery demand. The systems and methods of the present disclosure can dynamically select appropriate supply chain routing (e.g., choosing supplier, order routing to alternate suppliers, etc.), based in part on the digital replica (e.g., digital twin) simulation and associated predictions, to avoid supply issues and minimize delays.

In general, a supply chain is a network between an entity (e.g., company, manufacturer, etc.) and its suppliers to produce and distribute a specific product to the final buyer. This network can include different activities, people, entities, systems, information, and resources. The supply chain can also represent the steps it takes to get a product or service from its original state to the customer.

A supply chain can involve a series of steps/processes involved to get a product or service to a customer. The steps can include moving and transforming raw materials into finished products, transporting those finished products, and distributing the finished products to the end-user (e.g., customer, consumer, etc.). The entities involved in the supply chain can include producers, manufacturers, vendors, warehouses, logistics/transportation companies, distribution centers, and retailers. Generally, while making any final product, different components are required, and the components may be either manufactured by a same supplier or different suppliers in different geographical location, and finally assembled into the final product in a location before being delivered at a customer location.

In any shop floor, different machines may be used (e.g., the machines can be 3D printed machine, metal cutting machines, forming machines, etc.) to create different individual components for mass production. The quality and throughput from the machines can be dependent on the age, health, and current condition(s) of the machines. If there is an issue in any machine, the output from the machine may be reduced and/or the component quality may be reduced, until proper rectification of the issue can be completed. Alternatively, a supplier can increase capacity, for example, by installing new equipment/machines, upgrading equipment/machines, performing maintenance, and/or the like.

If any resource (e.g., machine, system, process, etc.) in a manufacturing floor is negatively impacted, for example, due to issues related to the health of the machine, then quality of the work product may deteriorate and/or throughput may be reduced. Additionally, if there is down time because of planned or unplanned maintenance, then there may be a reduction in the throughput. Such issues can create delivery delays to customers and may cause increases in cost.

The digital twin models can comprise digital replicas or representations of physical-world resources, machines, processes, services, systems, and/or the like associated with each entity (e.g., supplier, manufacturer, etc.) in a supply chain. The digital twin models can enable modeling, simulations, testing, monitoring, and/or the like of such resources and allow for minimizing disruptions, delays, and/or the like in the supply chain.

Embodiments of the present disclosure can provide real-time digital replica (e.g., digital twin) simulation of each machine and/or resource in any manufacturing shop floor and predict any change in throughput (e.g., reduced throughput, increased throughput, etc.) or quality related problem with work products. Accordingly, in any supply chain network, the systems and methods of the present disclosure can predict how different suppliers would be able to provide the required components (e.g., for a new order, etc.). If any change in throughput or quality is predicted for a supplier, the systems and methods of the present disclosure can dynamically assign the order to an appropriate supplier (e.g., alternate supplier) and identify the appropriate supply chain network routing.

This Detailed Description section is divided into the following sub-sections: The Hardware and Software Environment; Example Embodiments; Further Comments and/or Embodiments; and Definitions.

The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

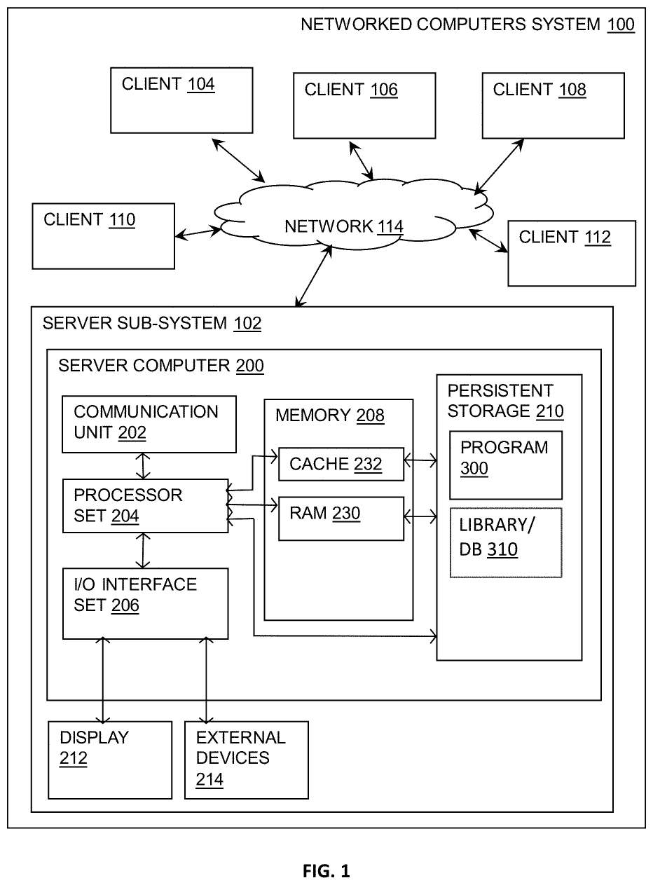

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine-readable instructions and/or data that can be used to create, manage, and control certain software functions, such as will be discussed in detail, below, in the Example Embodiment sub-section of this Detailed Description section. As an example, a program 300 can comprise digital twin simulation, supply chain routing, and/or the like. A library and/or database 310 may include substantive data associated with a plurality of digital twin models and may be accessed, for example by program 300, in utilizing (e.g., monitoring, controlling, generating data, analyzing, simulating, etc.) one or more digital twin models. Additionally and/or alternatively, a library and/or database 310 may include substantive data associated with a plurality of suppliers, components, products, and/or the like and may be accessed, for example by program 300, in generating supply chain predictions, supply chain routing determinations, and/or the like, such as discussed herein.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). For example, program 300 may include machine readable and performable instructions to provide for performance of method operations as disclosed herein. In this particular embodiment, persistent storage 210 includes a magnetic hard disk drive. To name some possible variations, persistent storage 210 may include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor, a smart phone/tablet display screen, and/or the like.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### EXAMPLE EMBODIMENTS

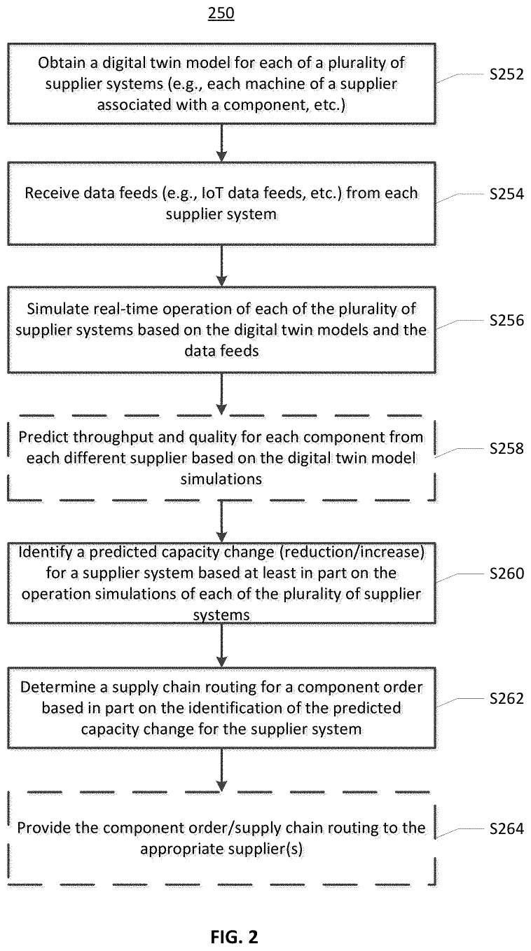

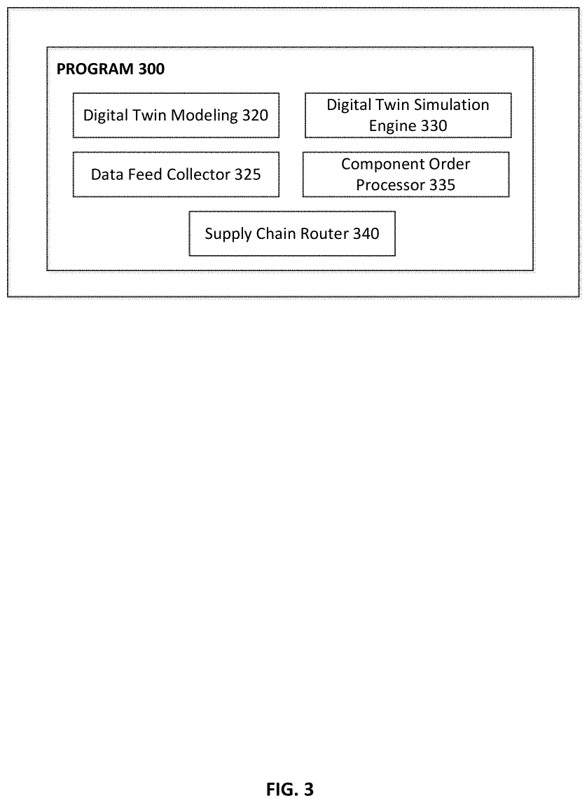

FIG. 2 shows flowchart 250 depicting a computer-implemented method, according to an embodiment of the present invention. FIG. 3 shows a program 300 for performing at least some of the method operations of flowchart 250. Regarding FIG. 2, one or more flowchart blocks may be identified with dashed lines and represent optional steps that may additionally be included, but which are not necessarily required, in the depicted embodiments. This method and associated software will now be discussed, over the course of the following paragraphs, with extensive reference to FIG. 2 (for the method operation blocks) and FIG. 3 (for the software blocks).

As illustrated in FIG. 2, in some embodiments, operations for supply chain routing determinations begin at operation S252, where a computing system (e.g., server computer 200 of FIG. 1 or the like) obtains a digital replica (e.g., digital twin) model (e.g., digital replica of physical machines, objects, processes, systems, services, etc.) for each machine and/or system of each entity in a supply chain network, for example, each machine associated with each supplier, manufacturer, and/or the like of components (e.g., parts, assemblies, work product, etc.) within a supply chain such as a supplier, manufacture. As an example, digital twin modeling module 320 of FIG. 3 and/or the like can access a digital replica (e.g., digital twin) library (e.g., library 310 of FIG. 1, etc.), identify associated parts for each machine of each supplier in the supply chain network along with associated data (e.g., model components, bill of materials, capabilities, features, etc.), and obtain a digital replica (e.g., digital twin) model for each supplier machine in the supply chain as appropriate to provide for real-time simulation of each machine in the supply chain network. Each machine of each supplier can be identified based on the types of components, work products, etc. that is generated.

Processing proceeds to operation S254, where the computing system (e.g., server computer 200 of FIG. 1 or the like) obtains a real-time data feed associated with each machine of each supplier in the supply chain, such as Internet of Things (IoT) data feeds and/or the like from each supplier machine. As an example, data feed collector module 325 and/or the like can provide for receiving data feeds from each machine located at each supplier where that data feeds provide indications of operational status, machine health status, and/or the like for each machine. The computing system may also obtain the location of each supplier, the supply chain components produced by each supplier, production capability of each supplier, product assembly location(s), service/maintenance plans, equipment ratings, and/or the like for use in generating supply chain routing decisions (e.g., order assignment, transportation/delivery routing, etc.).

Processing proceeds to operation S256, where the computing system (e.g., server computer 200 of FIG. 1 or the like) can simulate real-time operation of each of the plurality of supplier machines and/or systems based, at least in part, on the digital replica (e.g., digital twin) models and the data feeds. For example, the digital twin simulation engine 330 and/or the like can use the data feed associated with each machine of each supplier in association the d digital replica (e.g., digital twin) model for each machine to simulate operation of each supplier machine and monitor and/or predict the operation and/or health status of each machine. As an example, the digital twin simulation engine 330 can analyze the IoT feed from each machine and the digital replica (e.g., digital twin) of each machine to extrapolate the operational status (e.g., production capability, etc.) of each machine.

Optionally, in some embodiments, processing may continue to operation S258, where the computing system (e.g., server computer 200 of FIG. 1 or the like) can predict throughput and quality for each component from each different supplier based on the digital replica (e.g., digital twin) model simulations. For example, the digital twin simulation engine 330 and/or the like can identify the components produced by each supplier along with the production capabilities for each supplier and component and generate predictions of throughput and component quality for each supplier based on the digital replica (e.g., digital twin) simulations. In some embodiments, the computing system can use the predictions of throughput and component quality to determine how different suppliers can meet component demand, for example, to use in determining supply chain routing for component orders.

Processing proceeds to operation S260, where the computing system (e.g., server computer 200 of FIG. 1 or the like) can identify a predicted change in capacity (e.g., reduction, increase, etc.) for a supplier system based at least in part on the operation simulations of each of the plurality of supplier systems. For example, the digital twin simulation engine 330 and/or the like can analyze the digital replica (e.g., digital twin) models and data feeds associated with a supplier and predict any reductions, increases, etc. in production for each supplier. In some embodiments, the computing system (e.g., digital twin simulation engine 330 and/or the like) can identify any predicted change in throughput (reductions, increase, etc.), deterioration in quality for each supplier and/or quality improvement for each supplier, for example, based on historical or provided production capabilities of each supplier.

Processing proceeds to operation S262, where the computing system (e.g., server computer 200 of FIG. 1 or the like) can determine a supply chain routing for a component order based in part on the identification of the predicted change(s) for the supplier machine(s)/system(s). For example, the component order processor 335 and/or the like can obtain data associated with a new order (e.g., component type(s), bill of materials, order quantity, requested delivery timeline, etc.) and identifying suppliers of the supply chain network able to provide the requested components and if orders can be processed on schedule. The computing system (e.g., component order processor 335, digital twin simulation engine 330, and/or the like) can generate predictions of how different suppliers would be able to provide the requested components based on the digital replica (e.g., digital twin) simulations and any predicted change(s) in capacity/production for each supplier. The computing system (e.g., component order processor 335, digital twin simulation engine 330, supply chain router 340, and/or the like) can generate supply chain routing for the order, including assignment to an appropriate supplier, delivery timeline, and/or the like, based on the digital replica (e.g., digital twin) simulations and any predicted change in capacity/production for each supplier.

Optionally, in some embodiments, processing may continue to operation S264 where the computing system (e.g., server computer 200 of FIG. 1 or the like) can provide the component order/supply chain routing to the appropriate supplier(s). For example, the supply chain router 340 and/or the like can provide a component order to the appropriate supplier based on the supply chain routing determinations and any predicted changes(s) (e.g., reduced capacity, increased capacity, etc.) in production capabilities for a particular supplier. In some embodiments, the computing system (e.g., the component order processor 335, supply chain router 340, etc.) can determine a recommended delivery timeline for the component order.

### FURTHER COMMENTS AND/OR EMBODIMENTS

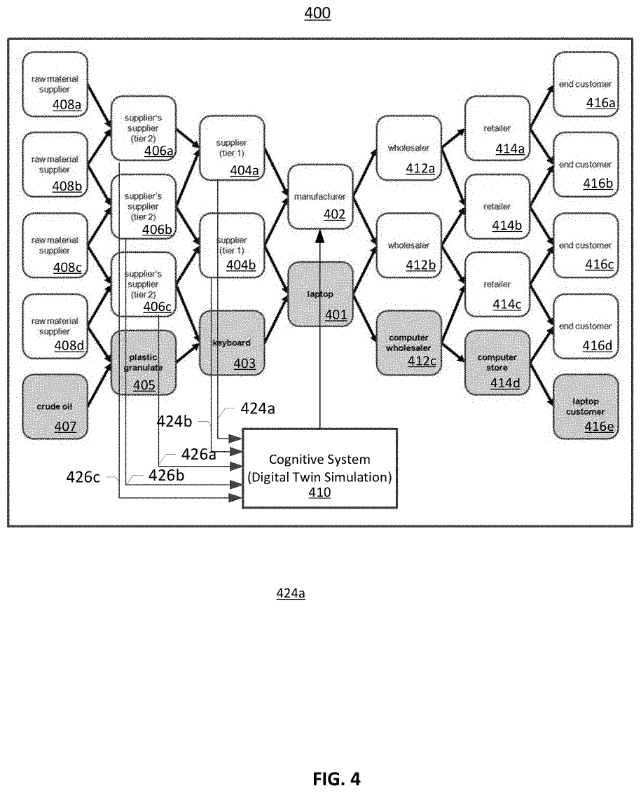

FIG. 4 is a block diagram showing an example of a supply chain network 400, according to the present invention. As illustrated in FIG. 4, in general, a supply chain is a network between an entity (e.g., manufacturer 402, etc.) and its suppliers (e.g., supplier 404a-404b, supplier's supplier 406a-406c, etc.) to produce and distribute a specific product (e.g., laptop 401, etc.) to the final buyer (e.g., consumer 416a-416d, etc.). This network can include different activities, people, entities, systems, information, and resources. The supply chain network can also represent the steps it takes to get a product or service from its original state to the customer.

A supply chain can involve a series of steps/processes involved to get a product or service to a customer. The steps can include moving and transforming raw materials into intermediate components at multiple levels, and transforming the components into finished products, transporting those finished products, and distributing the finished products to the end-user (e.g., customer, consumer, etc.). Generally, while making any final product, different components are required, and the components may be either manufactured by a same supplier or different suppliers in different geographical location, and finally assembled into the final product in a location before being delivered at a customer location. For example, a raw material supplier, such as raw material supplier 408a-408d, can supply raw material such as such as crude oil 407 to multiple tier 2 suppliers such as supplier's supplier 406a-406c for production of components such as plastic granules 405. A tier 2 supplier (e.g., supplier's supplier 406a, supplier's supplier 406b, supplier's supplier 406c, etc.) can provide the intermediate component (e.g., plastic granules 405, etc.) to a tier 1 supplier such as supplier 404a or supplier 404b who can in turn manufacture a component such as keyboard 403. A tier 1 supplier (e.g., supplier 404a, supplier 404b, etc.) can provide the component (e.g., keyboard 403, etc.) to the manufacturer (e.g., manufacturer 402) for production of a final product such as laptop 401.

For distribution of finished products, the manufacturer 402 can provide the finished product(s) to a wholesaler, such as wholesaler 412a-412c, who in turn can provide the product(s) to retailers, such as retailer 414a-414d, for sale to end-users, such as customers 416a-416e. For example, manufacturer 402 can produce laptop 401 and supply it to a computer wholesaler 412c. The computer wholesaler 412c can supply the laptop 401 to a computer store 414d which may sell products to end consumers. The computer store 414d may then sell and deliver the laptop 401 to a laptop customer 416e.

In some embodiments, digital replica (e.g., digital twin) simulation can be performed, (e.g., at cognitive system 410, etc.) to identify capabilities of each supplier (e.g., supplier 404a-404b, supplier's supplier 406a-406c, etc.) in supplier chain network 400. Data feeds, such as IoT feeds (e.g., data feeds 424a-424b, data feeds 426a-426c, etc.) can be provided from machines at each supplier to allow for the digital twin simulation engine to predict any quality changes (e.g., deterioration, improvements, etc.) and/or changes in throughput (e.g., increased throughput, reduced throughput, etc.) from any of the machines associated with any supplier (e.g., based on machine health status, operational reduction, etc.). The digital twin simulation engine can dynamically select an appropriate supply chain route (e.g., alternate supplier, delivery timeline, etc.) to minimize any disruptions of delays in component production/delivery and/or final product production/delivery.

In some embodiments, a cognitive system can complement the data received in the digital replica (e.g., digital twin) network to bring a more realistic view of the supply chain capability in terms of the available capacity to buyers. For example, predictions from digital replica (e.g., digital twin) simulations can be complemented by a cognitive system 410 that takes into account the information provided by the digital replica (e.g., digital twin) systems on available capacity, with stated information from the suppliers of other buyers to whom capacity has already been assigned and spare capacity available, as well as unstated information influence to determine the realistic capacity that could be taken up as assured from multiple suppliers to make up for a lost supplier's capacity. In such a cognitive system 410, the inputs can include the stated capacities, the digital twin network inputs, promised capacity, known additional buyers per supplier, and the unknown factor can be obtained as a neural network computes the probabilities of other breakdowns and probable capacity that can be obtained across other suppliers to make up the shortfall.

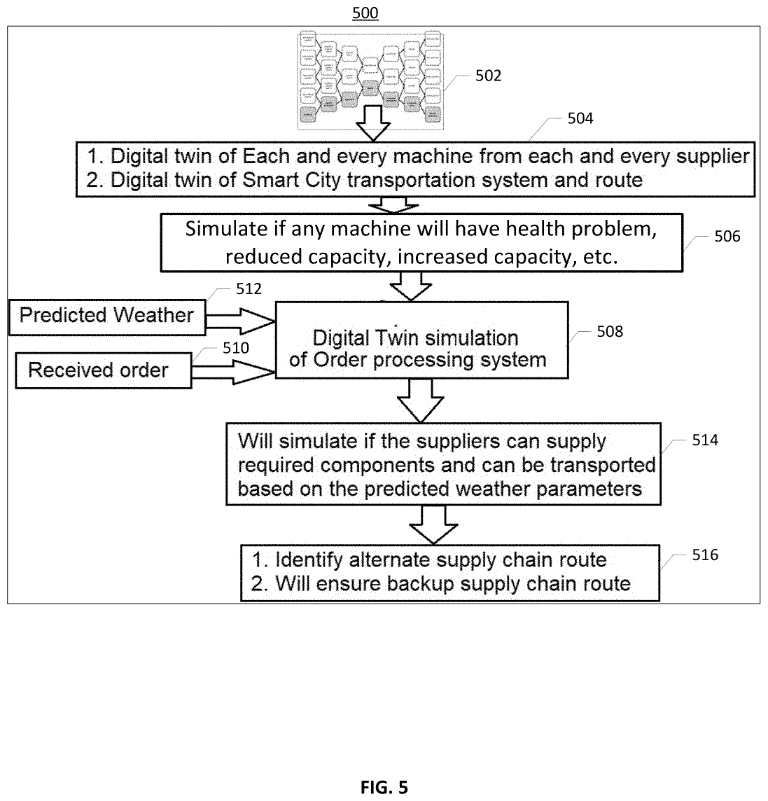

FIG. 5 provides a block diagram showing another embodiment system 500 for providing supply chain order routing determinations, according to the present invention. As illustrated in FIG. 5, a computing system can obtain information associated with a supply chain network 502. At block 504, the computing system can generate or otherwise obtain digital replica (e.g., digital twin) models for each machine for each supplier in the supply chain network 502. Each supplier machine can be identified by the types of components (e.g., parts, work product, etc.) produced by the machine. The computing system can identify each supplier, each supplier location, components provided by each supplier, production capabilities for each component, locations for processing/assembling to produce a final product, and/or the like. In some embodiments, the computing system can access a digital replica (e.g., digital twin) library to obtain the digital replica (e.g., digital twin) models and/or identify various parts of the machines for use in digital replica (e.g., digital twin) simulations of performance for each supplier machine. Each machine of each supplier can provide a data feed, such as an IoT feed, on a real-time basis for use in the digital replica (e.g., digital twin) simulations of supplier operations.

In some embodiments, the computing system can also obtain digital replica (e.g., digital twin) models of transportation systems, routing, traffic and/or the like associated with the supply chain network 502. The computing system may use such transportation digital replica (e.g., digital twin) models to simulate transportation routes for component orders, transportation performance, traffic, weather during a transportation period, and/or the like in different contextual situations and predict any delivery issues that might impact production or supply chain routing.

At block 506, the computing system can use the digital replica (e.g., digital twin) models of supplier machines along with the supplier data feeds, supplier capacity data, and the like to simulate production for each supplier and/or component. The computing system can simulate operations for each machine using the digital twin models and data feeds to predict if any machine will have health issues, operational issues, and/or other changes that might affect a supplier's production capacity (e.g., reduce capacity, increase capacity, etc.). The computing system can predict throughput and quality for each component from each different supplier based on the digital replica (e.g., digital twin) model simulations. The digital replica (e.g., digital twin) simulations can allow for predicting any changes in throughput or in component or work product quality for any supplier that might affect production and/or delivery timelines.

At block 508, the computing system can provide a digital replica (e.g., digital twin) simulation for an order processing system to allow for determining appropriate supply chain routing based on the digital replica (e.g., digital twin) simulations of supplier machines. The computing system can obtain new component/work product order(s) 510, including order quantity and requested delivery date of the order(s). The computing system can identify a bill of materials for the received order(s) and identify appropriate suppliers for different bill(s) of material.

In some embodiments, the computing system can obtain weather parameters and predicted weather information 512 for a specified duration of time (e.g., associated with component production, delivery, etc.). The computing system can simulate transportation routes, transportation performance, and/or the like in different weather conditions based on smart city digital replica (e.g., digital twin) models, transportation digital replica (e.g., digital twin) models, the predicted weather data, and/or the like. Based on such simulations, the computing system can predict issues due to different weather conditions (e.g., during different transportation periods, etc.) and determine appropriate supply chain routing to minimize the impact of weather conditions.

At block 514, the computing system can identify the current order and the digital replica (e.g., digital twin) simulation engine can simulate supplier performance to validate how different suppliers of the supply chain network 502 can provide the requested components or work products. The computing system can process the received orders, consider any current pending activities, and predict if the orders can be processed on time based, at least in part, on the digital replica (e.g., digital twin) simulations. In some embodiments, the computing system can simulate the transportation system(s), routing, etc. and predict if the components or work product cans be transported and delivered on schedule based on predicted weather parameters.

At block 516, the computing system can determine appropriate supply chain routing for the received order(s) including order assignment to a particular supplier, recommended delivery timeline(s), and/or the like. For example, if the digital replica (e.g., digital twin) simulations predict any issue(s) with production quality or throughput for a particular supplier, the computing system can determine an alternate supplier for the order to minimize disruptions and/or delays in production.

In some embodiments, the computing system may obtain data associated with required throughput and quality for components from each supplier. Based on real-time health status of machines of different suppliers across the geography from the digital replica (e.g., digital twin) simulations, required throughput and requited quality of the components or work products, the computing system (e.g., digital twin simulation engine) can identify optimum preventive maintenance for different machines of different supplier, so that optimum backup supply chain routes can be available for different situations.

In some embodiments, a cognitive system can obtain data indicative of the suppliers' capacity, known commitments to other buyers (e.g., quantities and/or assured capacity to them), probability of production failure(s), changes in capacity, and/or the like from digital replica (e.g., digital twin) simulation data, weather inputs, prior capacity matching by suppliers, and/or the like to determine the realistic capacity for each supplier that can be expected, and use this data in making supply chain routing determinations. The cognitive system can be trained from the buyer's experience, historical supplier information, as well as other public information available about each supplier.

### Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for supply chain order routing comprising:
obtaining, by a processor, a digital replica model for each of a plurality of supplier systems;
receiving data feeds from each of the plurality of supplier systems;
simulating real-time operation of each of the plurality of supplier systems based on the digital replica models and the data feeds;
identifying a predicted change in capacity for a supplier system based, at least in part, on the simulating of real-time operation of each of the plurality of supplier systems;
obtaining data associated with required throughput and quality for components from suppliers;
determining optimum preventive maintenance for different machines of suppliers based on the data associated with the required throughput and quality and the digital replica model simulations of real-time operation of each of the plurality of supplier systems; and
determining a supply chain routing for a component order based, at least in part, on the identification of the predicted change in capacity for the supplier system.

2. The computer-implemented method of claim 1, wherein the data feeds from each of a plurality of supplier systems comprise an Internet of Things data feed from each machine associated with each supplier in a supply chain network.

3. The computer-implemented method of claim 1, wherein the predicted change in capacity for the supplier system comprises a predicted reduction in production throughput or a predicted reduction in product quality.

4. The computer-implemented method of claim 3, wherein determining the supply chain routing for the component order comprises determining an alternate supplier for assignment of the component order in place of a supplier associated with the predicted reduction.

5. The computer-implemented method of claim 1, wherein the predicted change in capacity for the supplier system comprises a predicted increase in production throughput, and wherein determining the supply chain routing for the component order comprises determining an appropriate supplier for assignment of the component order.

6. The computer-implemented method of claim 1, wherein the digital replica model simulations of real-time operation of each of the plurality of supplier systems provide predictions of throughput and quality for each component from each different supplier.

7. The computer-implemented method of claim 1, further comprising determining a recommended delivery timeline for the component order based in part on the digital replica model simulations of real-time operation of each of the plurality of supplier systems.

8. (canceled)

9. The computer-implemented method of claim 1, further comprising:
obtaining digital replica models of transportation systems associated with each of a plurality of suppliers;
obtaining predicted weather data associated with a transportation period associated with the component order;
simulating transport and delivery for the component order based in part on the digital replica models of the transportation systems and the predicted weather data; and
determining modification to the supply chain routing for the component order based on the transport and delivery simulations.

10. The computer-implemented method of claim 1, wherein identifying a predicted change in capacity for the supplier system further comprises identifying capabilities of each supplier using a cognitive system along with the simulation of real-time operations.

11. A computer program product for supply chain order routing, the computer program product comprising one or more computer readable storage devices and program instructions sorted on the one or more computer readable storage devices to:
obtain a digital replica model for each of a plurality of supplier systems;
receive data feeds from each of the plurality of supplier systems;
simulate real-time operation of each of the plurality of supplier systems based on the digital replica models and the data feeds;
identify a predicted change in capacity for a supplier system based, at least in part, on the simulating of operations of each of the plurality of supplier systems;
obtain data associated with required throughput and quality for components from suppliers;
determine optimum preventive maintenance for different machines of suppliers based on the data associated with the required throughput and quality and the digital replica model simulations of real-time operation of each of the plurality of supplier systems; and
determine a supply chain routing for a component order based, at least in part, on the identification of the predicted change in capacity for the supplier system.

12. The computer program product of claim 11, wherein the data feeds from each of the plurality of supplier systems comprise an Internet of Things data feed from each machine associated with each supplier in a supply chain.

13. The computer program product of claim 11, wherein the predicted change in capacity for the supplier system comprises a predicted reduction in production throughput or a predicted reduction in product quality.

14. The computer program product of claim 13, wherein determining the supply chain routing for the component order comprises determining an alternate supplier for assignment of the component order in place of a supplier associated with the predicted reduction.

15. The computer program product of claim 11, wherein the digital replica model simulations of real-time operation of each of the plurality of supplier systems provide predictions of throughput and quality for each component from each different supplier.

16. The computer program product of claim 11, further comprising instruction to:
determine a recommended delivery timeline for the component order based in part on the digital replica model simulations of real-time operation of each of the plurality of supplier systems.

17. A computer system for supply chain order routing, the computer system comprising:
one or more computer processors;
one or more computer readable storage devices; and
computer program instructions stored on the computer readable storage devices comprising program instructions to:
obtain a digital replica model for each of a plurality of supplier systems;
receive data feeds from each of the plurality of supplier systems;
simulate real-time operation of each of the plurality of supplier systems based on the digital replica models and the data feeds;
identify a predicted change in capacity for a supplier system based, at least in part, on the simulating of operations of each of the plurality of supplier systems and a determination of supplier capabilities;
obtain data associated with required throughput and quality for components from suppliers;
determine optimum preventive maintenance for different machines of suppliers based on the data associated with the required throughput and quality and the digital replica model simulations of real-time operation of each of the plurality of supplier systems; and
determine a supply chain routing for a component order based, at least in part, on the identification of the predicted change in capacity for the supplier system.

18. The computer system of claim 17, wherein the data feeds from each of the plurality of supplier systems comprises an Internet of Things data feed from each machine associated with each supplier in a supply chain.

19. The computer system of claim 17, wherein the predicted change in capacity for the supplier system comprises one of:
a predicted reduction in production throughput;
a predicted reduction in product quality; and
a predicted increase in production throughput.

20. The computer system of claim 19, wherein determining the supply chain routing for the component order comprises determining an alternate supplier for assignment of the component order in place of a supplier associated with the predicted reduction in production throughput or the predicted reduction in product quality.
